(19) United States
(12) Patent Application Publication
(10) Pub. No.: US 2026/0347002 A1
(43) Pub. Date: Nov. 5, 2026

(54) AEROPLANE WINCHING SYSTEM

(71) Applicant: Bart LANSWEERS, Bodegraven (NL)

(72) Inventor: Bart LANSWEERS, Bodegraven (NL)

(21) Appl. No.: 19/118,145

(22) PCT Filed: Nov. 22, 2022
(86) PCT No.: PCT/NL2022/050673

§ 371 Date: Apr. 3, 2025

(51) Int. Cl. B64F 1/223; B64C 25/36; B64F 1/28

(52) U.S. Cl. CPC B64F 1/223; B64C 25/36; B64F 1/28

(57) ABSTRACT

The invention relates to an aeroplane winching system (100) for winching an aeroplane over a platform (10) having landing gear, comprising: a seat assembly (110) for seating at least part of the landing gear of the aeroplane; a winch (130) arranged to the platform; a cable for coupling the seat assembly and the winch for winching the seat assembly; and a seat guide (140) arranged for guiding the seat assembly; wherein the seat assembly comprises a fuel coupling (111, 11 T, 112) for coupling with the aeroplane for fueling the aeroplane while winching.

### FIELD OF THE INVENTION

The invention relates to an aeroplane winching system. The invention more specifically relates to an aeroplane winching system winching the aeroplane in an arc. The invention also relates to a method for winching an aeroplane in an arc. The invention also relates to use of an aeroplane winching system.

### BACKGROUND OF THE INVENTION

Aeroplanes taxi over the platform from and to aeroplane stands. The taxiing from aeroplanes is typically supported by a pushback truck, specifically designed to push back the aeroplane. If the aeroplanes taxi themselves, these taxiing aeroplanes need a larger platform. And before the aeroplanes are hooked to the pushback truck valuable time is lost.

### SUMMARY OF THE INVENTION

An object of the invention is to overcome one or more of the disadvantages mentioned above.

According to a first aspect of the invention, an aeroplane winching system for winching an aeroplane over a platform having landing gear, comprising:
a seat assembly for seating at least part of the landing gear of the aeroplane;
a winch arranged to the platform;
a cable for coupling the seat assembly and the winch for winching the seat assembly; and
a seat guide arranged for guiding the seat assembly;
wherein the seat assembly comprises a fuel coupling for coupling with the aeroplane for fueling the aeroplane while winching.

Aeroplanes or aircrafts may taxi over a platform. The current aeroplane winching system may support aeroplanes reaching their aeroplane stand. Aeroplanes have landing gear. The landing gear may comprise a main landing gear—MLG—typically supporting the main part of the weight of the aeroplane. The MLG is typically located close to the centre point of gravity of the aeroplane. The aeroplane typically has a centre line. The MLG typically is partly arranged on either side of the centre line. Further, the landing gear may comprise a centre wheel arranged to the centre line and to the centre point of gravity of the aeroplane. The landing gear typically comprises multiple wheels. Further, the landing gear typically comprises supports, typically substantially vertical supports. One end of the supports is attached to the airframe of the aeroplane, the other end of the supports is typically attached with at least one but often multiple wheels per support.

The seat assembly, preferably a seat comprised in the seat assembly, seats at least part of the landing gear. The seat assembly may engage the support of the landing gear. The seat assembly may preferably engage the wheel of the landing gear, such as the tyre of the wheel. The seat assembly may engage with both. The seat assembly may be configured to use one or a combination of engagements depending on the type of aeroplane. In an alternative embodiment, the seat assembly seats the MLG as well as the nose landing gear—NLG—. In an alternative embodiment, the seat assembly seats the MLG as well as the tail landing gear—TLG—.

The winch pulls on the cable when winching the seat assembly in. Typically, when winching the seated aeroplane, the aeroplane moves towards the winch. Several pullies are typically applied to lessen the stress on the cable and winching system. The winch is typically arranged to the platform, such as below the platform.

The seat guide guides the seat assembly along a predefined path. The seat guide prevents the cable from pulling the seat assembly along a random or arbitrary path. The seat guide may also cradle the cable. The seat guide is typically arranged below or flush with the platform. The seat assembly is typically arranged partly on top of the platform and partly below the platform. The part below the platform is typically comprising a coupling element coupling to the cable. The coupling element may comprise one or more pulleys over which the cable runs.

An aeroplane about to use the system engages the system by taxiing towards the seat assembly. Seating at least part of the landing gear may be performed by the aeroplane by just slowly advancing forward. The seat assembly, preferably a seat comprised in the seat assembly, may engage with a support of the landing gear and/or with one or more wheels of the landing gear. When seated or engaged, the seat assembly and thus the aeroplane is winched from a first location to a second location.

The fuel coupling is arranged for coupling with the aeroplane for fueling the aeroplane while winching. Fueling the aeroplane is typically allowed during that passengers are boarding or disembarking the aeroplane when the aeroplane is a double hull aeroplane. This embodiment advantageously allows to fuel the aeroplane while winching, optimizing the turn-around time of the aeroplane.

According to another aspect of the invention a method for winching an aeroplane over a platform having landing gear, comprising the steps of seating at least part of the landing gear in a seat assembly; winching the seat assembly over the platform; and guiding the seat assembly while winching in an arc. The method provides the same advantages as described for the aeroplane winching system does. Further, the method may be extended with features of features formulated as steps of any of the embodiments of the aeroplane winching system.

According to another aspect of the invention use of an aeroplane winching system according to any of the described embodiments. The use provides the advantages as described for the aeroplane winching system and the method for winching an aeroplane.

### DETAILED DESCRIPTION OF EXEMPLARY EMBODIMENTS

According to an embodiment, the seat guide comprises an arced section. The winched seat assembly and thus at least part of the landing gear follows an arced path dictated by the arced section. This advantageously allows to arrange the aeroplane at an aeroplane stand where the aeroplane was not able or very difficult to get to under its own power. This further advantageously reduces time of coupling with a pull or push system. This further advantageously simplifies the coupling of an aeroplane with a pull or push system.

The aeroplane winching system causes that the operator, such as the platform operator, typically present during taxiing to a standstill, may reverse the aeroplane at the same time. When the aeroplane is now departing, the aeroplane may taxi forward without the assistance of ground personal. In contrast, current systems require operators to be present during taxiing as well as during push back when the aeroplane is departing. This reverse or swap of operation step provides the advantage that the time of the ground personal is optimized, preferably such that one ground personal person may safely operate up to seven aeroplane winching systems in parallel.

According to an embodiment, the aeroplane winching system is arranged for winching the aeroplane backwards, preferably where the seat assembly is shaped to winch the aeroplane backwards. Often aeroplanes are not capable of going backwards or have to use full power and reversers to go backwards. Winching aeroplanes backwards provides the option of winching the aeroplanes to a spot on the platform where aeroplanes cannot come or have great difficulty to come under their own power. This allows to arrange the aeroplanes close to each other on platforms having a limited manoeuvring space. This allows more aeroplanes to be arranged on a platform and/or allows for a smaller platform. Further, winching aeroplanes backwards simplifies the procedure compared to pushing aeroplanes back with a push back truck. The aeroplane typically taxis under its own power on the seat assembly, whereafter the winching may start, without the time for coupling or engaging with the landing gear of a push back truck. Furthermore, the winch is always available as long as the final stand still location of the aeroplane is free. Thus, no time is lost waiting on the push back truck.

According to an embodiment, the aeroplane winching system comprises a breaking section with a predefined breaking load set before winching the aeroplane, and arranged for when broken prohibiting the winch from winching the seat assembly. Forces on the landing gear should not exceed a predefined threshold. When the forces exceed this threshold, the landing gear may damage. Damage on the landing gear may not show during taxiing but may show during take-off and landing the aeroplane with potential fatal consequences. For any reason, the aeroplane may be blocked or hold back for some reason. To prevent the aeroplane winching system from damaging the aeroplane, the system comprises breaking section.

According to an embodiment, the predefined breaking load is an adaptable predefined breaking load. Due to the different weights of different types of aeroplanes, the predefined breaking load for an aeroplane may be different.

According to an embodiment, the breaking section comprise:
first attachment means;
second attachment means; and
a stack of breaking strips each having a predefined breaking load, wherein at least one of the stack of breaking strips joins the first attachment means and the second attachment means. A stack of breaking strips wherein a specific number of breaking strips contribute to the predefined breaking load of the breaking section advantageously provide flexibility of selecting an appropriate predefined breaking load of the breaking section. The stack typically comprises a maximum of 10 breaking strips. The breaking strips are typically unique, such that when one breaking strip breaks, the other breaking strips become unusable for that other particular type aeroplanes. Unique breaking strips cause that the whole stack is to be replaced when one breaking strip breaks. Replacing the whole stack when one is broken ensures that the whole stack when none of the breaking strips is broken advantageously complies to all safety regulations or certifications, such as that is ensured that the breaking strips break at the predefined stress or load.

According to an embodiment, the number of breaking strips joining the first attachment means and the second attachment means determines the predefined adaptable breaking load. This advantageously makes clear no other coupling is made between the first and second attachment means, such that the predefined adaptable breaking load of the breaking section is only determined by the number of breaking strips joining these attachment means.

According to an embodiment, the first attachment means comprises a first pin; the second attachment means comprises a second pin; each breaking strip comprises at least one through hole; and the first pin is arranged through this at least one through hole of a breaking strip at least when this breaking strip contributes to the adaptable predefined breaking load. A pin linking all the breaking strips advantageously provides a simple design for the attachment means. The first pin advantageously provides that the breaking strips may be pivoted around this first pin.

According to a further embodiment, at least one breaking strip comprises a notch shaped for receiving the second pin and contributing to the adaptable predefined breaking load. Typically, the breaking strips are pivotally arranged around the first pin. When a breaking strip is pivoted from a first position where the second pin in not arranged inside the notch to a second position where the second pin is arranged inside the notch, this breaking strip does not contribute to the adaptable predefined breaking load in the first position and does contribute to the adaptable predefined breaking load in the second position. The pivoting of the breaking strip advantageously provides a simple design for a stack of breaking strips having an adaptable breaking load.

According to an embodiment, each breaking strip in the stack of breaking strips has a predefined breaking load different from all other breaking strips in the stack. This advantageously cause the complete stack of breaking strips to be replaced when one breaking strip is broken. Preferably, the breaking load of any combination of one or more breaking strips in the stack is unequal to any other combination of one or more breaking strips in the stack. This advantageously cause the complete stack of breaking strips to be replaced when one breaking strip is broken. In a particular embodiment, one of the breaking strips, typically the bottom one, conducts the for electrically powering the winch. The current conducting breaking strip is typically always used and rips when the load on the aeroplane while winching exceeds a predefined load or stress. When this current conducting breaking strip breaks, the current to the winch is automatically cut and the winch stops, such that damage, such as structural damage, to the aeroplane, particularly the landing gear is prevented. In a particular embodiment, the breaking strips are used from top-to-bottom. This advantageously causes the set of breaking strips used while winching to be at least the bottom one, preferably carrying the current for the winch, and every adjacent or next breaking strip in the stack to be when the stack of breaking strips is configured for winching a particular load. In a particular embodiment, the stack of breaking strips forms a cassette such that only the whole cassette is replaceable. This advantageously forces the operator to replace the whole stack for always having a certified stack of breaking strips while winching. Furthermore, the aeroplane winching system may comprise a breaking device arranged for breaking at least all unused breaking strips, when one or more of the breaking strips in the stack breaks. The breaking device may be advantageously arranged perpendicular to the stack such that if the part of the winch system accelerating due to breaking of one or more of the breaking strips together with the elastic energy build up in the cable while winching, at least the unused breaking strips, preferably all the breaking strips, impact the breaking device, such that at least the unused breaking strips, preferably all the breaking strips, break. This advantageously causes that all the breaking strips are to be replaced when at least one breaking strip breaks. This in turn ensures that the stack of breaking strips used while winching an aeroplane is certified. In a preferred embodiment, the stack of breaking strips takes into account the angle of the platform whereover the aeroplane is winched. This makes the stack of breaking strips specific and preferably certified for a specific installation of the aeroplane winching system on a specific platform. Specific types of the aeroplane winching system may be suitable for aeroplanes with up to nine passengers. Although more is certainly possible, below nine passengers the breaking strips are certified differently, typically more easily. For up to nine passengers, the aeroplane winching system may be operated by manual operation by the pilot and/or co-pilot or on-paper declaring in a time-zone all responsibility to the identity-soil the winching-system is installed and the individual pilot and/or co-pilot. For above nine passengers, the aeroplane winching system requires a skilled and certified or at least partly or semi certified airframe/powerplant personnel. All combi aeroplane are not downgraded passenger aeroplane and should stay within type certificate definition of the countries involved.

According to an embodiment, the breaking section is arranged between the cable and the seat assembly. As the breaking section breaks, this arrangement advantageously causes the winch to be unable to winch the seat assembly when broken fulfilling one of the safety requirements of the system. The safety requirement is that the system may never exceed a particular aeroplane winch load exceeding a predefined maximum load on the landing gear winched.

According to an embodiment, the aeroplane winching system comprises a flexible fuel hose having a proximal end coupled to a fuel line providing fuel and/or a distal end coupled to the seat assembly for providing fuel through the fuel coupling. The proximal end of the flexible fuel hose is typically coupled with a fuel line, such as a rigid and/or tubbed fuel line, providing the fuel from a storage tank. As the flexible fuel line is bendable, the rigid fuel line may couple to the flexible fuel line somewhere halfway the track the seat assembly travels along the seat guide. This embodiment advantageously allows to couple a stationary proximal end with a movable distal end.

According to an embodiment, the distal end of the flexible fuel hose is coupled to the seat assembly at an opposite side from the cable. The cable winched by the winch is typically running up and down between the winch and the seat assembly through several pullies at both sides. This cable may snap and after snapping may wrinkle or slam with force into everything close to where the cable normally runs. The reliability and safety are increased by coupling the flexible fuel hose on an opposite side of the seat assembly thereby preventing or at least minimizing the chance of a snapped cable to damage the flexible fuel hose.

According to an embodiment, the distal end has a substantially semi circled shape, such as in a 180-degree arc. This allows to couple the flexible fuel hose to the other side of the seat assembly while also letting the flexible fuel hose run towards the winch for locally there coupling the flexible fuel hose to a fuel line.

According to an embodiment, aeroplane winching system comprises a chain comprising links, wherein a link comprises a wall arranged between the cable and the flexible fuel hose. As the fuel hose typically runs from the winch to the seat assembly, the flexible fuel hose typically is arranged in the proximity of the cable, which may cause damage to the flexible fuel hose when the cable snaps. This wall advantageously prevents the cable from directly impacting the flexible fuel hose thereby advantageously increasing the safety and reliability.

According to an embodiment, the wall has a U-shape, wherein the bottom of the U-shape is arranged between the cable and the flexible fuel hose and/or the flexible fuel hose is arranged inside the U-shape. The U-shape provides the advantage of also providing a cover to the flexible fuel hose on more sides than only the side of the flexible fuel hose facing the cable. The legs of the U-shape are typically arranged above and below the flexible fuel hose. This advantageously increases safety and reliability. Furthermore, the U-shape advantageously allows a simpler link design such that the required flexibility, especially the 180-degree bend on the distal end near the seat assembly is easily provided.

According to an embodiment, at least one link comprises a holding element, such as a spacer, a spring or ring, arranged for providing spatial distance between the wall and the flexible fuel hose. This spatial distance allows for an additional safety zone when the cable impacts on the link when the cable snapped. The holding element is advantageously arranged such that if the link is forcefully accelerated by the impact of the cable on the link, the flexible fuel hose is not accelerated by the same amount decreasing the chance of a fuel line rupture. Alternatively, the holding element is advantageously arranged such that the cable cannot impact the flexible fuel hose directly.

According to an embodiment, the chain is bendable in an arc for coupling the chain together with the flexible fuel hose to the opposite side of the seat assembly. This arranges the flexible fuel hose advantageously on an opposite side where the cable may cause havoc when the cable snaps.

According to an embodiment, the seat guide advantageously comprises a straight section. According to an embodiment, the straight section advantageously comprises a first end and a second end opposite of the first end; the first end joins with the arced section; and the winch is arranged to the second end. According to an embodiment, the seat guide advantageously has the shape of a hockey stick. This advantageously allows a compact platform design or arranging more aeroplanes on a smaller platform. According to an embodiment, the aeroplane is advantageously winched from the arced section to the second end, thereby typically describing the hockey stick shape.

According to an embodiment, the arced section has an angle under 90 degrees, preferably below under 88 degrees, more preferably 87.5 degrees, most preferably 85 degrees; and/or the arced section has an angle over 15 degrees, preferably 25 degrees, more preferably 55 degrees, most preferably 70 degrees.

According to an embodiment, an aeroplane winching system comprises an elevated plateau elevated relative to the platform wherein the seat guide is partly arranged to the elevated plateau and partly arranged to the platform. The elevated plateau may be typed as a merlon with 45-degree edges. Arranging an aeroplane on an elevated plateau allows stacking or overlapping of wings of aeroplanes. This advantageously allows to arrange more aeroplanes on a smaller platform or more aeroplanes on a platform. The density of the aeroplanes on a platform is advantageously increased. Aeroplanes are typically not safely capable on their own power to get on the elevated plateau, the current embodiment of the system providing a safe solution. The elevated platform may be labelled a merlon, elevation, elevated flat, or obesities corrector. This is possible for aeroplanes with a maximum of five abreast seating.

According to an embodiment, the elevation relative to the platform is at least 1.5 metre, preferably 1.25 metre, more preferably 1 metre, more preferably 0.9 metre, more preferably 0.75 metre, more preferably 0.5 metre, most preferably substantially around 1 metre. The elevated aeroplane should be high enough to provide clearance between the own wings and wings of adjacent aeroplanes, such that these wings may overlap. The elevation should be high enough such that the clearance is enough for different types of aeroplanes. For some types of aeroplanes, the elevation should take into account the height of the winglet. From the other side, the elevation should not be too high, such that this height may cause a safety hazard for personnel or passengers boarding or disembarking the aeroplane. The arrangement of elevated planes relative to planes on the platform is typically calculated by certified software, such as embedded software.

According to an embodiment, an aeroplane winching system comprises a main ramp arranged for guiding the winched seat assembly from the platform to the elevated plateau, wherein the ramp has a slope below 12 degrees, preferably 10 degrees, more preferably 8 degrees, more preferably 6 degrees, more preferably 4 degrees, most preferably substantially around 6 degrees. The landing gear is typically arranged for a maximum impact angle when landing. This impact angle during landing provides an indicator for the maximum slope the aeroplane should be winched. The winching angle where the aeroplanes is winched over the slope is advantageously selected as not exceeding its landing angle.

According to an embodiment, the aeroplane has a centre line; the landing gear comprises a main landing gear having at least two wheels arranged on both sides of the centre line; and the seat assembly, preferably a seat comprised in the seat assembly, is adapted for seating the main landing gear, preferably a wheel of the main landing gear, more preferably a tyre of the wheel of the main landing gear. The tyre advantageously provides an air damper between the airframe of the aeroplane and the seat assembly or the seat of the winch system, more specifically between the wheel or tyre of the wheel and the shock. This air damper advantageously reduces the winch forces, such as changing winch loads on the landing gear, for increasing safety and preventing damage to the landing gear or aeroplane.

According to an embodiment, the seat assembly comprises: a bottom side; and multiple rollers arranged to the bottom side for rolling over the platform. This advantageously decreases the friction of the seat assembly with the platform, such that manual operation of the winch becomes possible. Manual operation of the winch allows to operate the winch during power outages or on platforms in the absence of electrical power. This simplifies the installation of the aeroplane winching system. In a further embodiment, the fuel pump is also manually operable such that the aeroplane may be fueled and parked manually during power outage or on small airstrips, which do not have the electricity. This provides a more robust and reliable aeroplane winching system. Furthermore, this brings back responsibility in the cockpit of the aeroplane.

According to an embodiment of the method, the step of winching is winching the aeroplane backwards. This advantageously allows to reverse taxi the aeroplane, such as reverse parking the aeroplane. This advantageously allows the aeroplane to safely reverse without or with minimum assistance of ground personal.

### BRIEF DESCRIPTION OF THE DRAWINGS

The invention will be apparent from and elucidated further with reference to the embodiments described by way of example in the following description and with reference to the accompanying drawings, in which:

FIG. 1 schematically shows a top view of an embodiment of an aeroplane winching system;

FIG. 2 schematically shows a perspective view of an embodiment of a seat assembly;

FIG. 3 schematically shows a perspective view of an embodiment of underground parts of a winching system;

FIG. 4 schematically shows a perspective view of an embodiment of flexible fuel hose guide;

FIG. 5 schematically shows a cross sectional view of an embodiment of a seat guide; and

FIG. 6 schematically shows a logo.

The figures are purely diagrammatic and not drawn to scale. In the figures, elements which correspond to elements already described may have the same reference numerals.

LIST OF REFERENCE NUMERALS

| | |
|---|---|
| 10 | tarmac or platform |
| 100 | aeroplane winching system |
| 110 | seat assembly |
| 111 | first fuel coupling |
| 111′ | second fuel coupling |
| 112 | combined fuel coupling |
| 113 | first shock |
| 114 | second shock |
| 115 | connecting plate |
| 116 | handle |
| 117 | hinge |
| 118 | main plate |
| 119 | walking opening |
| 120 | underground part seat assembly |
| 121 | first flexible fuel hose guide |
| 122 | second flexible fuel hose guide |
| 130 | winch |
| 131 | winch coil |
| 140 | seat guide |
| 141 | arced section |
| 142 | straight section |
| 143 | first fuel hose and cable chamber |
| 144 | second fuel hose and cable chamber |
| 145 | third cable chamber |
| 146 | fourth cable chamber |
| 147 | first track |
| 148 | second track |
| 150 | elevated plateau |
| 151 | main ramp |
| 152 | swing bar |
| 153 | corrugated board |
| 154 | individual curved ramp |
| 155 | top part seat assembly |
| 156 | seat |
| 157 | half tube |
| 158 | reinforcing plates |
| 160 | arced flexible fuel hose guide |
| 161 | first chain link type |
| 162 | second chain link type |
| 163 | fuel hose opening |
| 164 | protective wall |
| 165 | holding element |
| 166 | inspection opening |
| A | aeroplane approach direction |
| B | winching direction |

### DETAILED DESCRIPTION OF THE FIGURES

The following figures may detail different embodiments. Embodiments can be combined to reach an enhanced or improved technical effect. These combined embodiments may be mentioned explicitly throughout the text, may be hint upon in the text or may be implicit.

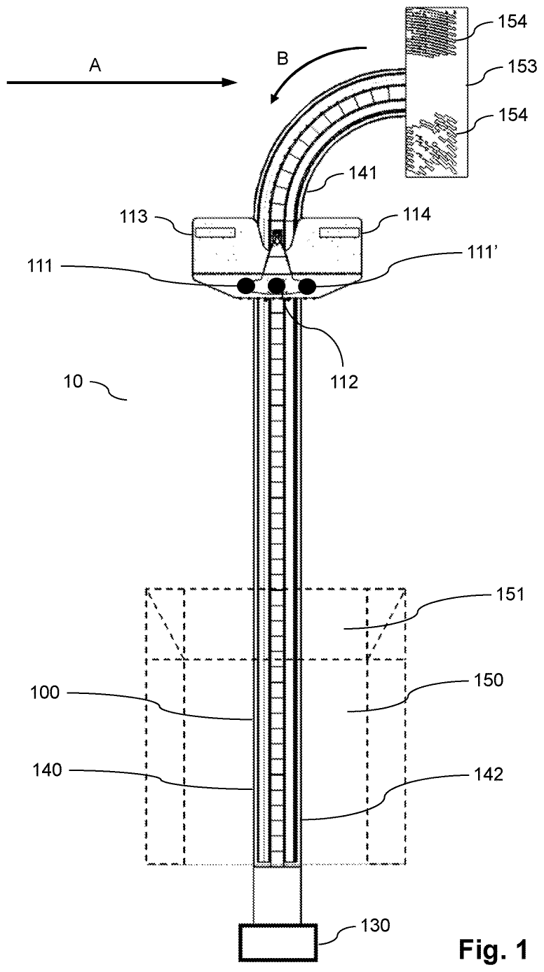

FIG. 1 schematically shows a top view of an embodiment of an aeroplane winching system 100 arranged to a platform 10. The system is typically partly arranged on top, flush with the platform, and below the platform. The system comprises a seat assembly 110, a winch 130, and a seat guide 140. The seat guide may comprise an arced section 141. The system also comprises a cable coupling the seat assembly and the winch for winching the seat assembly. The cable is not shown in the figure as it is arranged inside the seat guide below the platform. The winch may be powered electrically or by hand. The winch may be operated via a wired remote control. The ground personnel may handle the wired remote control or hand tool. The seat guide may comprise an arced section 141 and may comprise a straight section 142. The seat assembly typically comprises a part arranged on top of the platform. The seat assembly may comprise a first shock 113 arranged for receiving a left main landing wheel of the aeroplane. The seat assembly may comprise a second shock 114 arranged for receiving a right main landing wheel of the aeroplane. The first and second shock may be popping up shocks, such as variable popping up shocks for being able to handle different or variable wheel diameters. Shocks are typically designed such that the aeroplane may ride over the shocks when the engines are at sufficient power. The seat assembly may comprise a first fuel coupling 111 arranged for coupling with a hose or extendable to directly couple with the fuel coupling of the aeroplane, such as the wing fuel coupling. The seat assembly may comprise a second fuel coupling 111′ arranged for coupling with a hose or extendable to directly couple with the fuel coupling of the aeroplane, such as the wing fuel coupling. In an alternative embodiment, the seat assembly may comprise a combined fuel coupling 112.

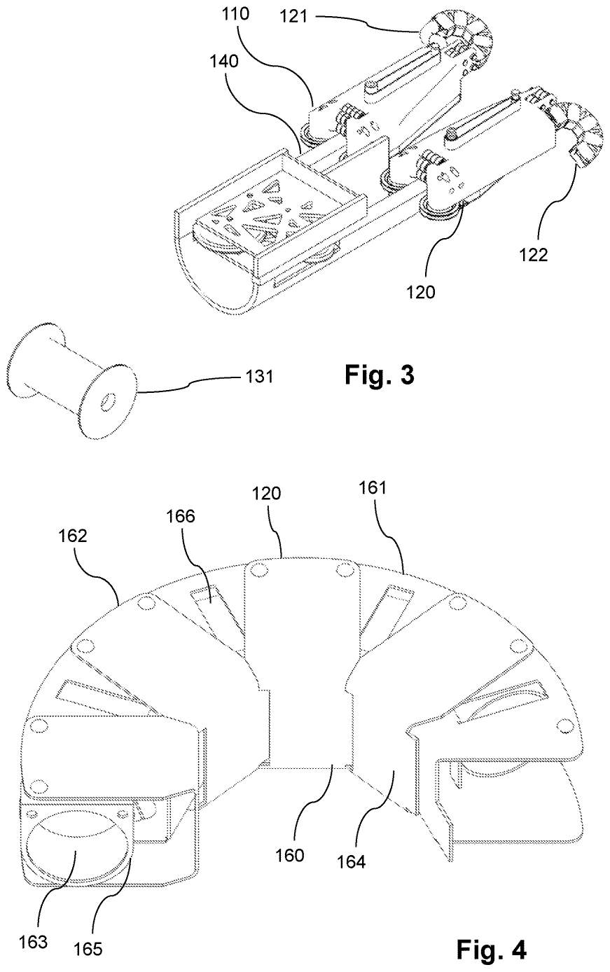

The seat assembly 110 may comprises a top part 155 above the ground and an underground part 120, see FIG. 3, under the ground. The top part may comprise a main plate 118. The top part may comprise a seat 156 for seating an aeroplane, preferably a landing gear, more preferably a tyre of an aeroplane. The aeroplane winching system may comprise a corrugated board 153. The corrugated board is shaped to cooperate with the seat assembly for allowing the top part of the seat assembly to sink into the platform such that the top part, specifically the main plate, is flush with the platform in a distal position distal from the winch. This allows the aeroplane to taxi with minimal effort onto the seat for being winchable thereafter. The top part of the seat assembly rises from the corrugated board typically under an angle of 3 degrees, and/or under a maximum angle of 6 degrees. To allow the top part to rise while the main plate is level, the underside of the main plate may comprise rollers spread out over the underside of the main plate. Furthermore, the corrugated board may comprise individual ramps 154 having a track each for one cooperating roller, such that each roller is assigned an individual track. The main plate may rise while the main plate is also traversing through the arced section. The individual ramps and tracks for each roller may therefore be arced shaped as schematically shown in FIG. 1.

The aeroplane typically taxies over the platform in a forward direction A. Aeroplanes are typically not able to taxi in a reverse direction or backwards or additional wear in the motors is caused during reverse taxiing. Furthermore, reverse taxiing has the inherent difficult of that the field of view of the pilot is blocked by the aeroplane itself thereby highly increasing the threat of running into an obstacle. Typically, in conventional situations, a wing tip observer is used for safely taxing or towing an aeroplane especially backwards. The current system allows controlled and secure reversing of an aeroplane, preferably fewer ground personnel, such as without a wing tip observer, to assist or even be present in the local vicinity of the system. Furthermore, the fuel couplings allow to fuel the aeroplane while reversing. As fueling is typically allowed when passengers are embarking and disembarking for double hulled aeroplanes, fueling while reversing decreases the turnaround time of the aeroplane.

When the aeroplane is slowly taxiing in the forward direction A and aligned to the middle of the seat assembly, the nose wheel passes between the first and second shock and the wheels of the main landing gear will contact the first and second shock stopping the aeroplane on the seat assembly, preferably the seat. The wheels, more specific the tyres, advantageously provide an air suspension damper reducing the changed winch-force preventing damage to the main landing gear. The pilot applies the brakes of the main landing gear for fixating the main landing gear wheels on the seat assembly, preferably the seat. Optionally, the fuel coupling is made to start refuelling the aeroplane. Thereafter the seat assembly with the aeroplane on top, travels backwards in the direction B. This travelling backward reverse parks the aeroplane, such that the aeroplane may be parked e.g. at the edge of a platform between other planes.

The system may comprise an elevated plateau 150 and a main ramp 151. The main ramp allows the seat assembly to gradually go upwards from the platform to the elevated plateau while being winched. When the aeroplane is arranged on the elevated plateau, the wings of the aeroplane may overlap with the wings of an aeroplane parked next to the elevated platform without touching these wings of the other aeroplane. This advantageously allows to minimize the space taken by the parked planes on the platform.

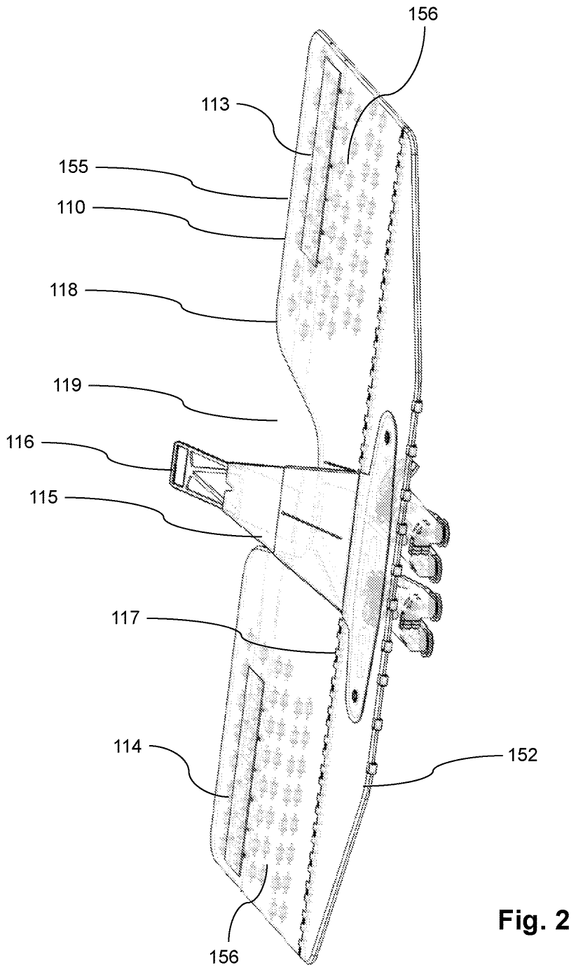

FIG. 2 schematically shows a perspective view of an embodiment of a seat assembly 110. The seat assembly may further comprise a main plate 118, a handle 116, a hinge 117, a walking opening 119, and a connecting plate 115. The main plate may comprise a seat 156. The main plate is typically arranged flat or flush on the platform when the system is ready for receiving an aeroplane for winching. The connecting plate joins the main plate via the hinge. On the other end of the connecting plate is the handle arranged. Further, the walking opening is arranged to the handle for allowing a person to pick up the handle and walk the seat assembly back out, such as away from the winch to the other end of the seat guide. In another embodiment, a second winch may be used to arrange the seat assembly at the other end of the seat guide compared to the winch. The seat assembly may comprise a swing bar 152 joining the main plate with the underground part of the seat assembly, typically rotationally joining. This advantageously allows the nose wheel to deviate slightly from the ideal line while the seat assembly with the aeroplane is winched while during the winching no excessive stresses are exercised on this nose wheel. In an embodiment, the main plate may comprise extension wings extending the main plate to the side for allowing aeroplanes with a widely placed main landing gear, such as Saab aeroplanes.

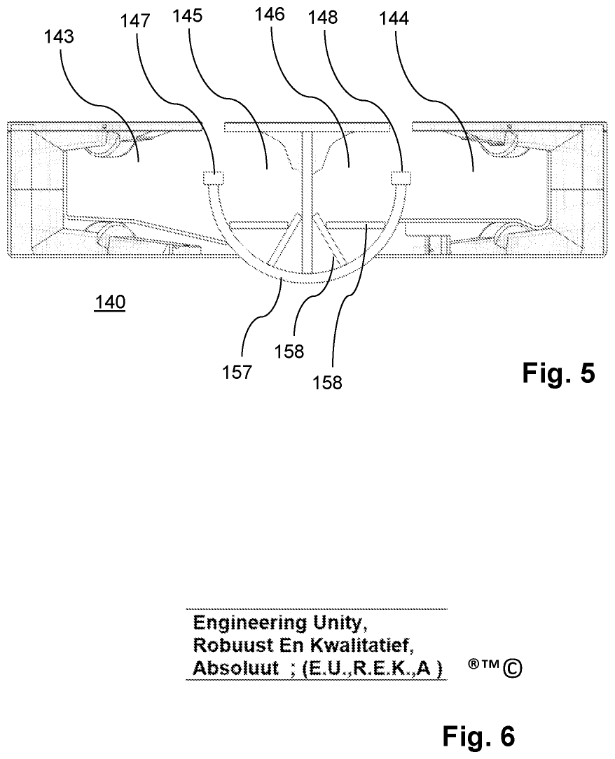

FIG. 3 schematically shows a perspective view of an embodiment of underground parts of a winching system. The winching system comprises a seat assembly 110 comprising an underground part 120 of the seat assembly. FIG. 3 further shows the winch coil 131 of the winch 130 and the seat guide 140. The winch coil is shown to indicate the direction the underground part is winched. For clarity reasons the cable between the underground part and the winch coil is not shown. Further the seat guide and/or guidance of the seat guide is detailed in the cross-section in FIG. 5. The cable typically runs several times up and down between the winch and the underground part before ending on the winch coil for advantageously reducing the force applied on an individual section of the cable. Furthermore, the motor of the winch may advantageously apply less force during winching. The underground part of the seat assembly may comprise a first flexible fuel hose guide 121 arranged for guiding a first flexible fuel hose while the seat assembly is winched. The underground part of the seat assembly may comprise a second flexible fuel hose guide 122 arranged for guiding a second flexible fuel hose while the seat assembly is winched. The first and second flexible fuel hose end in the first and second fuel coupling comprised in the seat assembly, respectively. The first and second flexible fuel hose guides may be considered as a chain comprising links. Each link typically comprises a wall arranged between the cable and the flexible fuel hose. The first and second chain together with the first and second flexible fuel hose respectively provide a double hull fuel line or near double hull fuel line. Together with a double hull aeroplane, the system forms an arrangement which complies to the highest standards as applied in selected countries requiring this double hull standard. The seat assembly typically comprises an underground part of the seat assembly and a main plate securely joint to each other, such that when the underground part is winched, the main plate moved together with the underground part.

FIG. 4 schematically shows a perspective view of an embodiment of a first flexible fuel hose guide 122, more specific the flexible fuel hose guide is shown while arced or bend 160. The flexible fuel hose guide is built up as a chain. The chain may comprise a first chain link type 161 and a second chain link type 162. The chain links all may have a U-shape. The chain links have a shape that they snugly fit into or over each other when bend. The chain link, such as the first chain link may comprise an inspection opening for inspecting the flexible fuel hose. The flexible fuel hose guide may comprise a holding element 165 comprising a fuel hose opening 163 wherethrough or wherein the fuel hose may be arranged. The fuel hose opening typically snugly fits around or even clamping onto the flexible fuel hose preventing the flexible fuel hose to shift or slip relative to the fuel hose opening and thus preventing wear of the flexible fuel hose.

The bottom of the U-shape is arranged for facing the cables, such that the chain links, specifically the bottom of the U-shape form a protective wall 164 between the fuel hose and the cable, such that when a cable breaks or snaps, and/or cable detaches from the seat assembly due to breaking of the breaking strips the cable cannot impact the fuel hose directly. This protective wall together with the flexible fuel hose provide a double hull fuel line or near double hull fuel line. Together with a double hull aeroplane, the system forms an arrangement which complies to the highest standards as applied in selected countries requiring this double hull standard.

FIG. 5 schematically shows a cross sectional view of an embodiment of a seat guide 140. The seat guide may comprise a first fuel hose and cable chamber 143 and a second fuel hose and cable chamber 144 arranged for respectively guiding a first and second flexible fuel hose to the seat assembly, and respectively guiding cables to the seat assembly. The seat guide may comprise a third cable chamber 145 and a fourth cable chamber 146. The cable between the winch and the seat assembly may run through these respective cable chambers. The seat guide may comprise a first track 147 arranged for allowing rollers of the seat assembly to run over the first track while winching. The seat guide may comprise a second track 148 arranged for allowing rollers of the seat assembly to run over the second track while winching. The first and second track are coupled with each other by a tube half 157. The bottom part of the tube half is reinforced by plates 158 forming reinforcing triangles. The system may advantageously be split in four sections such that 3 systems fit in one 12-metre-long container, which is in logistics a standard size container especially for containers used on ships.

FIG. 6 schematically shows a logo used for developing and designing the current aeroplane winching system for qualified aeroplanes.

Examples, embodiments or optional features, whether indicated as non-limiting or not, are not to be understood as limiting the invention as claimed. It should be noted that the figures are purely sketches or diagrammatic and not drawn to scale. In the figures, elements which correspond to elements already described may have the same reference numerals.

The term “substantially” herein, such as in “substantially all emission” or in “substantially consists”, will be understood by the person skilled in the art. The term “substantially” may also include embodiments with “entirely”, “completely”, “all”, etc. Hence, in embodiments the adjective substantially may also be removed. Where applicable, the term “substantially” may also relate to 90% or higher, such as 95% or higher, especially 99% or higher, even more especially 99.5% or higher, including 100%. The term “comprise” includes also embodiments wherein the term “comprises” means “consists of”.

The term “functionally” will be understood by, and be clear to, a person skilled in the art. The term “substantially” as well as “functionally” may also include embodiments with “entirely”, “completely”, “all”, etc. Hence, in embodiments the adjective functionally may also be removed. When used, for instance in “functionally parallel”, a skilled person will understand that the adjective “functionally” includes the term substantially as explained above. Functionally in particular is to be understood to include a configuration of features that allows these features to function as if the adjective “functionally” was not present. The term “functionally” is intended to cover variations in the feature to which it refers, and which variations are such that in the functional use of the feature, possibly in combination with other features it relates to in the invention, that combination of features is able to operate or function. For instance, if an antenna is functionally coupled or functionally connected to a communication device, received electromagnetic signals that are receives by the antenna can be used by the communication device. The word “functionally” as for instance used in “functionally parallel” is used to cover exactly parallel, but also the embodiments that are covered by the word “substantially” explained above. For instance, “functionally parallel” relates to embodiments that in operation function as if the parts are for instance parallel. This covers embodiments for which it is clear to a skilled person that it operates within its intended field of use as if it were parallel.

Furthermore, the terms first, second, third and the like in the description and in the claims, are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein.

The devices, tools or apparatus herein are amongst others described during operation. As will be clear to the person skilled in the art, the invention is not limited to methods of operation or devices in operation.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “to comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device, tool or apparatus claims enumerating several means, several of these means may be embodied by one and the same item of hardware. The mere fact that certain measures are recited in mutually different dependent claims does not indicate that a combination of these measures cannot be used to advantage.

The invention further applies to an apparatus, a tool or device comprising one or more of the characterising features described in the description and/or shown in the attached drawings. The invention further pertains to a method or process comprising one or more of the characterising features described in the description and/or shown in the attached drawings or figures.

The various aspects discussed in this patent can be combined in order to provide additional advantages. Furthermore, some of the features can form the basis for one or more divisional applications.

1. An aeroplane winching system for winching an aeroplane over a platform having landing gear, the aeroplane winching system comprising:
a seat assembly for seating at least part of the landing gear of the aeroplane, the seat assembly having a fuel coupling for coupling with the aeroplane for fueling the aeroplane while winching;
a winch arranged to the platform;
a cable for coupling the seat assembly and the winch for winching the seat assembly; and
a seat guide arranged for guiding the seat assembly.

2. The aeroplane winching system of claim 1, further comprising a flexible fuel hose having a proximal end coupled to a fuel line providing fuel and/or a distal end coupled to the seat assembly for providing fuel through the fuel coupling, wherein the distal end is coupled to the seat assembly at an opposite side from the cable, and the distal end has a substantially semi-circle shape having a 180-degree arc.

3-4. (canceled)

5. The aeroplane winching system of claim 2, further comprising a chain comprising links, wherein a link comprises a wall arranged between the cable and the flexible fuel hose, and wherein:
the wall has a U-shape with a bottom thereof arranged between the cable and the flexible fuel hose, and/or the flexible fuel hose is arranged inside the U-shape,
at least one link comprises a holding element arranged for providing spatial distance between the wall and the flexible fuel hose, and/or
the chain is bendable in an arc for coupling the chain together with the flexible fuel hose to the opposite side of the seat assembly.

6-8. (canceled)

9. The aeroplane winching system of claim 1, wherein the aeroplane winching system is arranged for winching the aeroplane backwards, and where the seat assembly is shaped to winch the aeroplane backwards.

10. The aeroplane winching system of claim 1, further comprising a breaking section with a predefined breaking load set before winching the aeroplane, and arranged for when broken prohibiting the winch from winching the seat assembly.

11. The aeroplane winching system of claim 10, wherein the predefined breaking load is an adaptable predefined breaking load.

12. The aeroplane winching system of claim 11, wherein the breaking section comprises:
first attachment means;
second attachment means; and
a stack of breaking strips each having a predefined breaking load, wherein at least one of the stack of breaking strips joins the first attachment means and the second attachment means.

13. The aeroplane winching system of claim 12, wherein the number of breaking strips joining the first attachment means and the second attachment means determines the predefined adaptable breaking load.

14. The aeroplane winching system of claim 13, wherein:
the first attachment means comprises a first pin;
the second attachment means comprises a second pin;
each breaking strip comprises at least one through hole;
the first pin is arranged through this at least one through hole of a breaking strip at least when this breaking strip contributes to the adaptable predefined breaking load; and
at least one breaking strip comprises a notch shaped for receiving the second pin and contributing to the adaptable predefined breaking load.

15. (canceled)

16. The aeroplane winching system of claim 12, wherein:
each breaking strip in the stack of breaking strips has a predefined breaking load different from all other breaking strips in the stack,
the breaking load of any combination of one or more breaking strips in the stack is unequal to any other combination of one or more breaking strips in the stack,
the breaking strips are used from top-to-bottom, and
the stack of breaking strips form a cassette such that only the whole cassette is replaceable.

17. The aeroplane winching system of claim 10, wherein the breaking section is arranged between the cable and the seat assembly.

18. The aeroplane winching system of claim 17, wherein the seat guide comprises:
an arced section, and/or
a straight section.

19. (canceled)

20. The aeroplane winching system of claim 18, wherein:
the straight section comprises a first end and a second end opposite of the first end;
the first end joins with the arced section; and
the winch is arranged to the second end;
the seat guide has the shape of a hockey stick; and
the aeroplane is winched from the arced section to the second end.

21-22. (canceled)

23. The aeroplane winching system of claim 18, wherein:
the arced section has an angle under 90 degrees; and
the arced section has an angle over 15 degrees.

24. The aeroplane winching system of claim 1, further comprising an elevated plateau elevated relative to the platform wherein the seat guide is partly arranged to the elevated plateau and partly arranged to the platform.

25. The aeroplane winching system claim 24, wherein the elevation relative to the platform is at least 1.5 metre.

26. The aeroplane winching system of claim 24, further comprising a main ramp arranged for guiding the winched seat assembly from the platform to the elevated plateau, wherein the ramp has a slope below 12 degrees.

27. The aeroplane winching system of claim 1, wherein:
the aeroplane has a centre line;
the landing gear comprises a main landing gear having at least two wheels arranged on both sides of the centre line; and
the seat assembly is adapted for seating a wheel of the main landing gear.

28. The aeroplane winching system of claim 1, wherein the seat assembly comprises:
a bottom side; and
multiple rollers arranged to the bottom side for rolling over the platform.

29-30. (canceled)

31. Use of the aeroplane winching system of claim 1.
